(19) United States
(12) Patent Application Publication
(10) Pub. No.: US 2017/0103841 A1
(43) Pub. Date: Apr. 13, 2017

(54) MAGNETIC STRUCTURE

(71) Applicant: Delta Electronics, Inc., Taoyuan City (CN)

(72) Inventors: Chao YAN, Taoyuan City (CN); Ruifei TIAN, Taoyuan City (CN)

(73) Assignee: Delta Electronics, Inc., Taoyuan City (CN)

(21) Appl. No.: 15/279,740

(22) Filed: Sep. 29, 2016

(30) Foreign Application Priority Data
Oct. 12, 2015 (CN) 201510657599.0

(51) Int. Cl. H01F 27/20; H01F 27/24; H01F 27/32

(52) U.S. Cl. CPC H01F 27/20; H01F 27/325; H01F 27/24

(57) ABSTRACT

A magnetic structure includes at least one bobbin and a core. Each of the bobbin has at least one winding portion in which a through passage is provided along its longitudinal direction, the core has at least one column, the column is received in the through passage so that a heat dissipation space is formed between an outer wall of the column and an inner wall of the through passage. In the magnetic structure according to the present disclosure, during the operation of the magnetic structure, the heat generated from the column and from an inner layer of a coil wound on the winding portion both can be quickly dissipated through the heat dissipation space, and thus the heat dissipation efficiency of the magnetic structure according to the present disclosure is improved.

### CROSS REFERENCE

This application is based upon and claims priority to Chinese Patent Application No. 201510657599.0, filed on Oct. 12, 2015, the entire contents thereof are incorporated herein by reference.

### TECHNICAL FIELD

The present disclosure relates to a magnetic structure.

### BACKGROUND

With reference to FIG. 1, FIG. 1 is a schematic view showing a conventional magnetic structure having a PQ-type core. The magnetic structure includes a core 1 and a bobbin 2. The core 1 includes a central column 11 and two side columns 12 symmetrically provided at opposite sides of the central column 11. The bobbin 2 includes a winding portion for winding a coil, and a through passage is provided in the winding portion along its longitudinal direction.

When assembling the core 1 and the bobbin 2, in order to enable the central column 11 of the core 1 to be smoothly inserted into the through passage of the winding portion, the through passage has inner diameter sized slightly larger than outer diameter of the central column 11. For example, the size of the inner diameter of the winding portion in PQ32/30 type is about 13.85 mm, and the minimum diameter of the central column of the core is about 13.25 mm, and a maximum gap therebetween is about 0.6 mm (referring to Soft Ferrites and Accessories 05 Data Handbook).

After the core 1 and the bobbin 2 are assembled to form the magnetic structure, in order to improve the mechanical reliability of the magnetic structure, the magnetic structure is immersed into varnish. After immersing into the varnish, the gap between the central column 11 and the through passage is filled with the varnish. Therefore, the gap once presented between the central column 11 and the though passage during the manufacturing process of the magnetic structure is a kind of assembly tolerance only for the purpose of assembling, and after the magnetic structure has been completed, the gap is filled with a layer of varnish 100.

With reference to FIG. 2, FIG. 2 is a schematic view showing structure of a conventional magnetic structure having a ETD-type core. Same as the magnetic structure shown in FIG. 1, in the magnetic structure having ETD-type core, the gap between the central column 11 and the through passage is only an assembly tolerance for meeting the assembly requirement, and after the magnetic structure is completed, the gap is filled with a layer of varnish 100.

With reference to FIG. 3 and FIG. 4, FIG. 3 is a schematic view showing a conventional magnetic structure having a E-type core, and FIG. 4 is a enlarged view showing the assembly relationship between a central column and a bobbin in the magnetic structure having the E-type core as shown in FIG. 3. The magnetic structure includes a core 1 and a bobbin 2. The core 1 includes a cover plate 13, and a central column 11 and two side columns 12 fixed on the cover plate 13, and the side columns 12 are symmetrically provided at opposite sides of the central column 11. The bobbin 2 has a winding portion 20 for winding a coil 200, and the winding portion 20 is provided with a through passage along its longitudinal direction. Same as the magnetic structure as shown in FIG. 1 above, in the magnetic structure having the E-type core, the gap between the central column 11 and the through passage is also an assembly tolerance for meeting the assembly requirement, and after the magnetic structure is completed, the gap is filled with a layer of varnish 100.

With reference to FIG. 3 and FIG. 4, it can be seen that there are two heat dissipation and conduction paths for the central column 11, one of which is that heat is conducted from the central column 11, through the cover plate 13, and finally to external space; and the other path is that the heat is conducted from the central column 11, through the varnish layer 100, the winding portion 20, the coil 200, and finally to the external space. During operation of the magnetic structure, a massive amount of heat is generated from the coil, and if being a multi-layer coil, the heat from the inner layer of the coil has to be conducted through the winding portion 20, the varnish layer 100, the central column 11, the cover plate 13, and finally to the external space, or the heat from the inner layer of the coil is conducted to the external space through the outer layer of the coil. In the conventional magnetic structure having the E-type core, the heat dissipation path for the central column 11 and the heat dissipation path for the inner layer of the coil both have relative large thermal resistance, resulting in low heat dissipation efficiency, and the other conventional magnetic structure, such as that shown in FIG. 1 and FIG. 2, also suffer from the same defect of low heat dissipation efficiency.

The above information disclosed in the background technology section is only used to facilitate understanding the background of the present disclosure, and thus it may include information which does not construct the prior art well-known by the person skilled in the related art.

### SUMMARY

The present disclosure is to provide a magnetic structure with high heat dissipation efficiency.

The additional aspects and advantages of the present disclosure will be partly set forth in the following description, and partly become apparent from the description, or learned from the practice of the present disclosure.

According to an aspect of the present disclosure, a magnetic structure including at least one bobbin and a core is provided. Each of said bobbins has at least one winding portion in which a through passage is provided along its longitudinal direction. The core has at least one column, the column is received in the through passage, and a heat dissipation space surrounding the column is provided between an outer wall of the column and an inner wall of the through passage.

In the magnetic structure of the present disclosure, the heat dissipation space is provided between the outer wall of the column of the core and the inner wall of the winding portion of the bobbin and the column is received in the heat dissipation space, during the operation of the magnetic structure the heat generated from the column and the heat generated from the inner layer of the coil provided on the winding portion can be quickly dissipated through this heat dissipation space, and therefore, the magnetic structure of the present disclosure has high heat dissipation efficiency.

### BRIEF DESCRIPTION OF THE DRAWINGS

The above and other features and advantages of the present disclosure will become more apparent by describing the exemplified embodiment in detail with reference to the attached figures.

FIG. 1 is a schematic view showing a conventional magnetic structure having a PQ-type core;

FIG. 2 is a schematic view showing a conventional magnetic structure having a ETD-type core;

FIG. 3 is a schematic view showing a conventional magnetic structure having a E-type core;

FIG. 4 is an enlarged view showing assembly relationship between a central column and a bobbin in the magnetic structure as shown in FIG. 3;

FIG. 5 is a schematic view showing structure of a first embodiment of a magnetic structure according to the present disclosure;

FIG. 5A to FIG. 5E are schematic views respectively showing that the columns with any cross sectional shape and the through passages with any cross sectional shape are arbitrarily fitted with each other;

FIG. 6 is a schematic view showing structure of a second embodiment of the magnetic structure according to the present disclosure;

FIG. 7 is a schematic view showing a heat sink further provided on the basis of the embodiment as shown in FIG. 6;

FIG. 8 is a schematic view showing structure of a third embodiment of the magnetic structure according to the present disclosure;

FIG. 8A is a schematic view showing structure of another bobbin in the third embodiment of the magnetic structure;

FIG. 9 is a schematic view showing structure of a fourth embodiment of the magnetic structure according to the present disclosure;

FIG. 9A and FIG. 9B are schematic views showing structure of a hollowed-out portion provided in the fourth embodiment of the magnetic structure;

FIG. 10A is a simulation effect view showing the temperature field of the conventional magnetic structure having the PQ-type core as shown in FIG. 1; and

FIG. 10B is a simulation effect view showing the temperature field of the magnetic structure having the PQ-type core according to the present disclosure as shown in FIG. 6.

### DETAILED DESCRIPTION

Now, exemplary embodiments of the present disclosure will be more fully described with reference to the attached drawings. However, the exemplary embodiments can be implemented in various ways, and should not be construed as being limited to the embodiments set forth herein, rather, these embodiments are provided so that the present disclosure will be thorough and complete, and will fully convey the scope of the present disclosure to the person skilled in the related art. Throughout the drawings, the same reference numerals are used to refer to the same or similar structure, and thus its detail description will be omitted as necessary.

According to the present disclosure, a magnetic structure includes a core and at least one bobbin. The core has at least one column, and each of the bobbins has at least one winding portion, and a through passage is provided in each of the winding portions along its longitudinal direction. One column is received in each of the throughout passages, and a heat dissipation space surrounding the column is formed between an outer wall of the column and an inner wall of the winding portion.

In the present disclosure, a sufficient heat dissipation space can be left between the column of the core and the through passage by increasing cross-sectional area of the through passage or reducing cross-sectional area of the column of the core, or by increasing the cross-sectional area of the through passage and reducing the cross-sectional area of the column of the core at the same time, so that heat dissipation medium can be introduced into the heat dissipation space. The heat from the column of the core can be quickly dissipated by directly contacting the column of the core with the heat dissipation medium, such as air, heat sinks, and so on, and the heat from an inner layer of a coil wound on the winding portion can also be quickly dissipated through the winding portion and the heat dissipation space. Hereinafter, various embodiments of the magnetic structure according to the present disclosure will be described in detail.

### First Embodiment

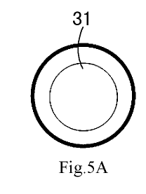

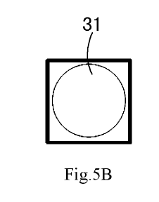

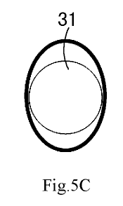

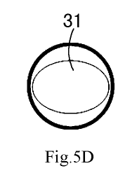

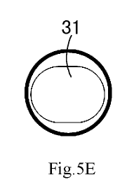

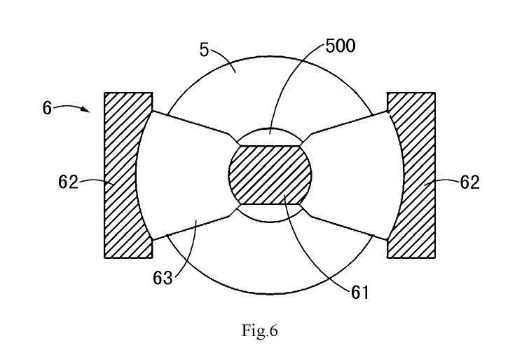

With reference to FIG. 5, FIG. 5 is a schematic view showing the structure of a first embodiment of a magnetic structure according to the present disclosure. The first embodiment of the magnetic structure according to the present disclosure includes a E-type core 3 and a bobbin 4.

The E-type core 3 includes a cover plate 33, and a central column 31 and two side columns 32 fixed on the cover plate 33, wherein the two side columns 32 are symmetrically provided at opposite sides of the central column 31. In this first embodiment, the structure of the core is not limited to the E-type core, and other types of core, for example, an axial symmetry type core, such as ETD-type, PQ type, or the like can also be applied in the first embodiment of the present disclosure.

The bobbin 4 includes a winding portion (not shown in Figures) for one or more coils to be wound thereon, and a through passage is provided in the winding portion along its longitudinal direction.

The central column 31 of the E-type core 3 is inserted in the through passage of the winding portion, optionally, a longitudinal central line of the central column 31 is identical with a longitudinal central line of the through passage. A heat dissipation space 400 is formed between an outer wall of the central column 31 and an inner wall of the winding portion, and the central column 31 is received in the heat dissipation space 400. By this heat dissipation space 400, heat generated from the central column 31 and heat generated from an inner layer of the coil wound on the winding portion can be quickly dissipated.

In this first embodiment, optionally, at the same cross section of the winding portion, when cross-sectional area of the central column 31 is about 80% of the cross-sectional area of the through passage (a cross section perpendicular to the longitudinal direction of the winding portion), the heat dissipation efficiency of the magnetic structure can be significantly improved. In the disclosure, the ratio of the cross-sectional area of the central column 31 to the cross-sectional area of the through passage is not limited to 80%, for example, the ratio can also be 70%, 60%, 50%, and so on.

With reference to FIG. 5A to FIG. 5E, FIG. 5A to FIG. 5E are schematic views showing that the columns with any cross section shapes and the through passages with any cross section shapes are arbitrarily fitted with each other. In this first embodiment, the through passage may have a cross section in circular, oval, rectangular, or running track shape, and the central column 31 may have a cross section in circular, oval, rectangular, or running track shape. The central column 31 with any cross section shape can be arbitrarily fitted each other with the through passage of any cross section shape. For example, referring to FIG. 5A, the central column 31 with circular cross section fitted in the through passage with circular cross section is shown; referring to FIG. 5B, the central column 31 with circular cross section fitted in the through passage with rectangular cross section is shown; referring to FIG. 5C, the central column 31 with circular cross section fitted in the through passage with oval cross section is shown; referring to FIG. 5D, the central column 31 with oval cross section fitted in the through passage with circular cross section is shown; and referring to FIG. 5E, the central column 31 with running track shaped cross section fitted in the through passage with circular cross section is shown. It will be appreciated that the above description relating to fitness between the columns with various cross section shapes and the through passages with various cross section shapes one by one is only for illustration, but not to construct limitation on the scope of the disclosure.

### Second Embodiment

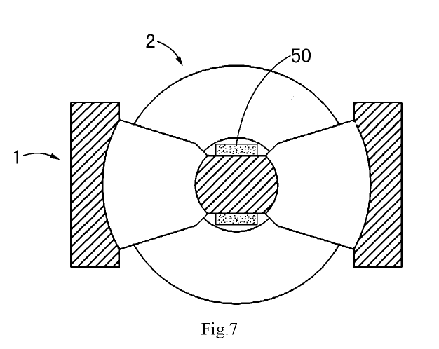

With reference to FIG. 6, FIG. 6 is a schematic view showing structure of a second embodiment of the magnetic structure according to the present disclosure.

The core in this second embodiment is a PQ-type core 6. The PQ-type core 6 includes a cover plate 63, and a central column 61 and two side columns 62 fixed on the cover plate 63, wherein the side columns 62 are symmetrically provided at opposite sides of the central column 61.

A bobbin 5 has a winding portion, and a through passage is provided in the winding portion along its longitudinal direction. The central column 61 is provided in the through passage of the winding portion, and a heat dissipation space 500 is formed between an outer wall of the central column 61 and an inner wall of the winding portion.

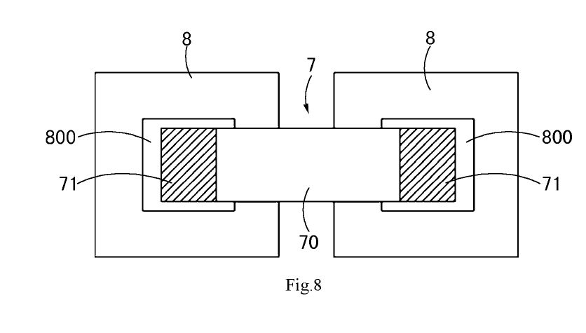

With reference to FIG. 7, in this second embodiment, optionally, one or more heat sinks 50 are disposed around the central column 61 in the heat dissipation space 500, and the heat sinks 50 may be metal heat sinks, such as copper heat sinks, aluminum heat sinks, and so on. The heat sinks 50 are used to enhance the ability of the magnetic structure to dissipate heat.

Other structures in the second embodiment of the magnetic structure are the same as that in the first embodiment, and will not be further described herein.

### Third Embodiment

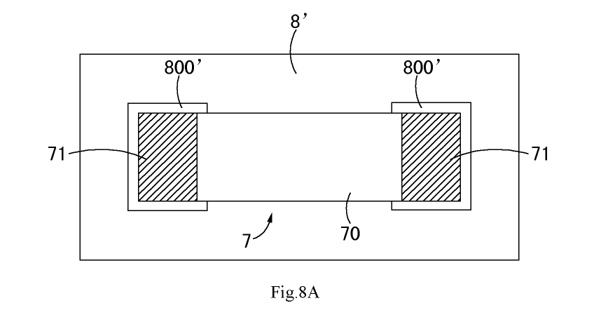

With reference to FIG. 8, FIG. 8 is a schematic view showing structure of a third embodiment of the magnetic structure according to the present disclosure. The third embodiment of the magnetic structure according to the present disclosure is different from the first embodiment in that:

The third embodiment includes a U-type core 7 and two bobbins 8.

The U-type core 7 includes a cover plate 70 and two side columns 71 fixed on the cover plate 70. In this third embodiment, the core structure is not limited to the U-type core, and other types of core, for example, an UR-type core, an UI-type core, or the like can also be feasible.

The two bobbins 8 may have the same structure, and each of the bobbins 8 has a winding portion, in which a through passage is provided along its longitudinal direction.

The two side columns 71 of the U-type core 71 are respectively inserted into the respective through passages of the two bobbins. A heat dissipation space 800 is formed between each of the side columns 71 and each of the through passages.

With reference to FIG. 8A, FIG. 8A is a schematic view showing structure of another bobbin 8′ in the third embodiment of the magnetic structure, and the bobbin 8′ is used to take the place of the two bobbins as shown in FIG. 7. The bobbin 8′ has two winding portions which are arranged to be parallel with each other. Each of the winding portions has one through passage. The two side columns of the U-type core 7 are respectively inserted into the respective through passages of the two winding portions. A heat dissipation space 800′ is formed between an outer wall of each of the side columns 71 and an inner wall of its corresponding through passage.

Other structures in the third embodiment of the magnetic structure are the same as that in the first embodiment, and will not be further described herein.

### Fourth Embodiment

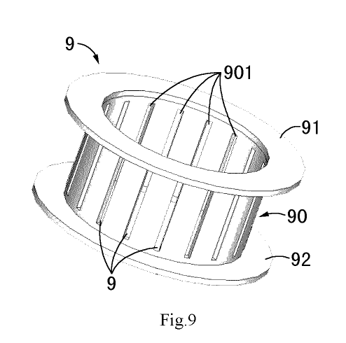

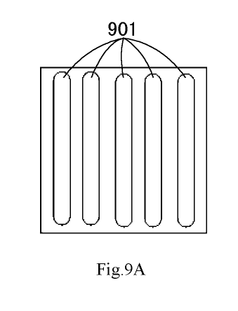

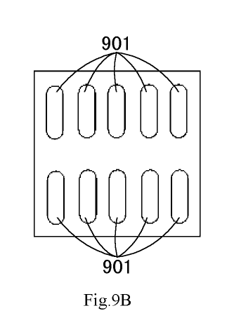

With reference to FIG. 9, FIG. 9 is a schematic view showing structure of a fourth embodiment of the magnetic structure according to the present disclosure. In the fourth embodiment, the bobbin is further improved based on the previous three embodiments.

The bobbin 9 includes a cylindrical winding portion 90, and an upper baffle 91 and a lower baffle 92 provided at opposite ends of the winding portion 90. A coil is provided around the winding portion 90 and between the upper baffle 91 and the lower baffle 92.

The winding portion 90 is provided with at least one hollowed-out portion 901, the hollowed-out portion 901 is penetrated through an outer wall and an inner wall of the winding portion for air flowing therethrough.

With reference to FIG. 9A and FIG. 9B, the hollowed-out portion 901 on the winding portion 90 is of rectangular, circular, running track, rounded-corner rectangular, or oval shape. The hollowed-out portions 901 may be extended along a direction parallel to a central line of the winding portion, and the hollowed-out portions 901 may be arranged into two rows or more rows. With the hollowed-out portions 901, it is possible to improve the heat conductivity of the winding portion, allow the heat generated in the inner layer of the coil wound on the winding portion 90 to be conducted to the heat dissipation space more easily, and thus to improve the heat dissipation efficiency of the inner layer of the coil.

Other structures in the fourth embodiment of the magnetic structure are the same as that in the first embodiment, and will not be further described herein.

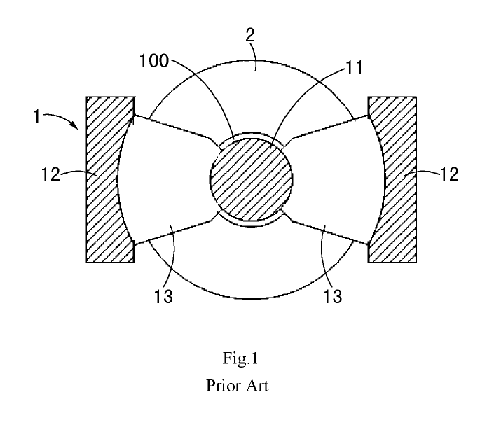

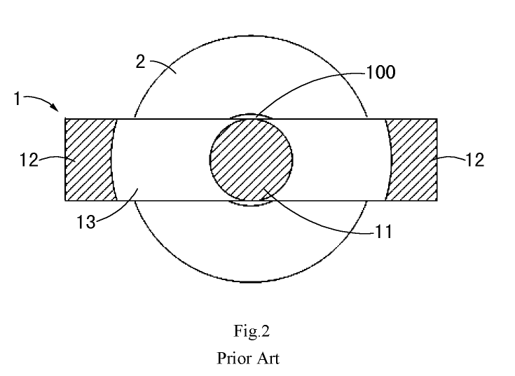

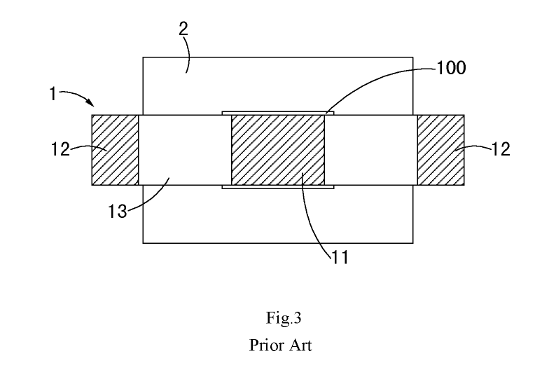

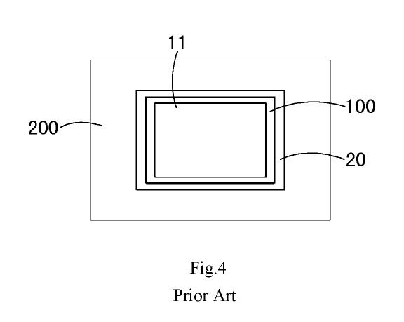

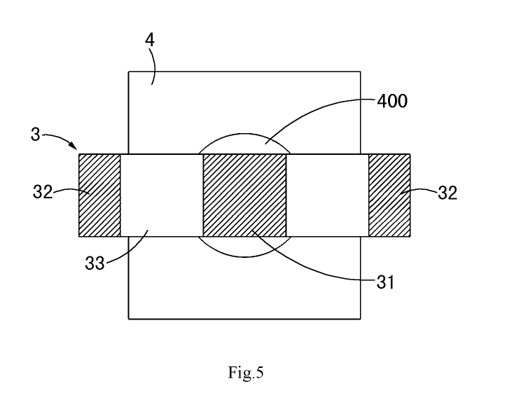

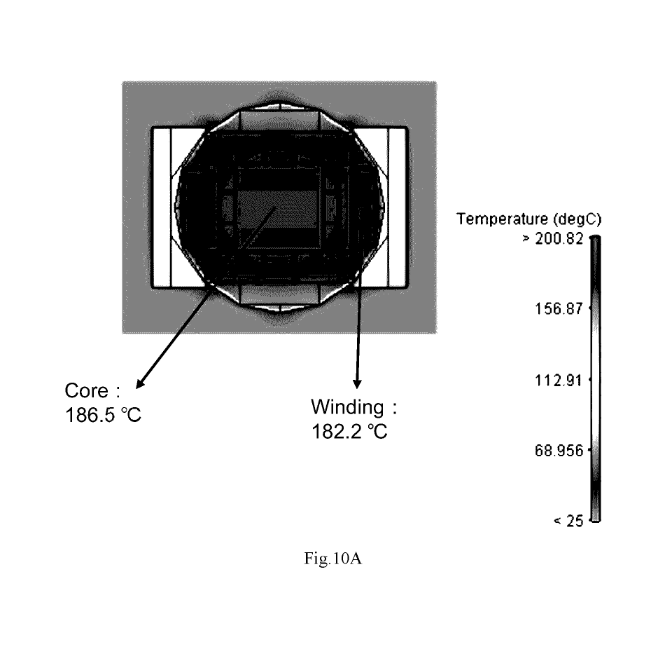

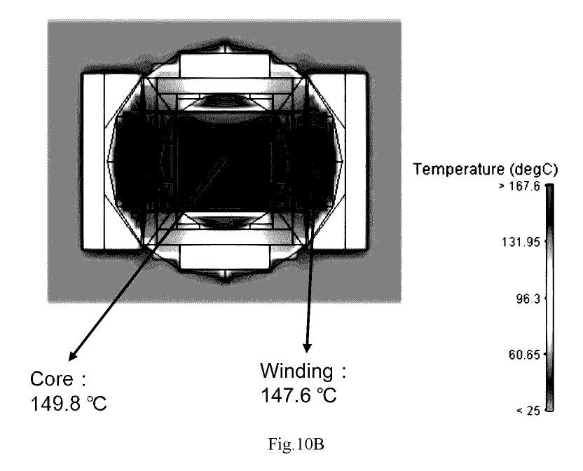

With reference to FIG. 10A and FIG. 10B, FIG. 10A is a simulation effect view showing temperature field of the conventional magnetic structure having the PQ-type core as shown in FIG. 1, and FIG. 10B is a simulation effect view showing temperature field of the magnetic structure having the PQ-type core according to the present disclosure as shown in FIG. 6.

In the magnetic structure having the PQ-type core according to the present disclosure as shown in FIG. 6, the heat dissipation space is provided between the central column 61 and the winding portion, and in the radial direction of the cross section of the winding portion, the maximum distance from the central column 61 to the inner wall of the winding portion is about 5 mm.

The magnetic structure as shown in FIG. 1 and the magnetic structure as shown in FIG. 6 are placed in the same heat dissipation environment (e.g. forced air cooled), the same amount of heat is generated, for example, the amount of heat generated from the central column 100 is about 100 Walt, and the amount of heat generated from the coil is about 100 Walt. As shown by the simulation result in FIG. 10A and FIG. 10B, the temperature of the central column 61 in the magnetic structure according to the present disclosure as shown in FIG. 6 is lower than the central column 11 in the conventional magnetic structure as shown in FIG. 1 by 36.7 degree; and the temperature of the coil in the magnetic structure according to the present disclosure as shown in FIG. 6 is lower than the temperature of the coil in the conventional magnetic structure as shown in FIG. 1 by 34.6 degree. From above, it can be seen that in the magnetic structure according to the present disclosure, by providing the heat dissipation space between the central column of the core and the through passage of the winding portion, the ability of the magnetic structure to dissipate heat can be largely improved.

The present teaching is specially suitable for the magnetic structure with high power and high heat productivity, such as a magnetic structure having a core with no less than 8000 cubic millimeter volume, and the heat dissipation efficiency and heat dissipation effect are more remarkable

The exemplary embodiments of the present disclosure have been particularly shown and described above It is appreciated that the present disclosure should not be limited to such disclosed embodiments, rather it is intended that the present disclosure covers various modifications and equivalent arrangements fallen within the sprit and scope of the appended claims.

What is claimed is:

1. A magnetic structure, wherein the magnetic structure comprises:
at least one bobbin, each of which is provided with at least one winding portion in which a through passage is provided along its longitudinal direction; and
a core provided with at least one column, wherein the column is received in said through passage, and a heat dissipation space surrounding said column is formed between an outer wall of said column and an inner wall of said winding portion.

2. The magnetic structure according to claim 1, wherein, at the same cross section of said winding portion, the cross-sectional area of the column is no more than 80% of the cross-sectional area of the through passage.

3. The magnetic structure according to claim 1, wherein the core has volume no less than 8000 cubic millimeter.

4. The magnetic structure according to claim 1, wherein the magnetic structure further comprises a cover plate connecting with the column.

5. The magnetic structure according to any one of claim 1, wherein the cross section of the through passage is of circular, oval, rectangular, or running track shape.

6. The magnetic structure according to any one of claim 1, wherein the cross section of the column is of circular, ellipse, rectangular or running track shape.

7. The magnetic structure according to any one of claim 1, wherein the through passage has a longitudinal central line coincided with that of the column.

8. The magnetic structure according to any one of claim 1, wherein the column is a central column or a side column of the core.

9. The magnetic structure according to any one of claim 1, wherein the core comprises a central column and two side columns provided at opposite sides of the central column, and the central column is received in the through passage.

10. The magnetic structure according to claim 9, wherein the core is of E-type, PQ-type or ETD-type.

11. The magnetic structure according to any one of claim 2, wherein the core comprises a central column and two side columns provided at opposite sides of the central column, and the central column is received in the through passage.

12. The magnetic structure according to any one of claim 3, wherein the core comprises a central column and two side columns provided at opposite sides of the central column, and the central column is received in the through passage.

13. The magnetic structure according to any one of claim 1, wherein the core comprises two side columns, and the two side columns are respectively received in two said through passages.

14. The magnetic structure according to claim 13, wherein the core is of U-type, UR-type or UI-type.

15. The magnetic structure according to any one of claim 1, wherein one or more heat sinks are disposed around the column in the heat dissipation space.

16. The magnetic structure according to any one of claim 2, wherein one or more heat sinks are disposed around the column in the heat dissipation space.

17. The magnetic structure according to any one of claim 3, wherein one or more heat sinks are disposed around the column in the heat dissipation space.

18. The magnetic structure according to any one of claim 11, wherein one or more heat sinks are disposed around the column in the heat dissipation space.

19. The magnetic structure according to any one of claim 1, wherein the winding portion is provided with at least one hollowed-out portion, and the hollowed-out portion is penetrated through an outer wall and an inner wall of the winding portion.

20. The magnetic structure according to claim 19, wherein the hollowed-out portion is of rectangular, circular, running track, rounded-corner rectangular or oval shape.
